(19) United States
(12) Patent Application Publication
(10) Pub. No.: US 2025/0323449 A1
(43) Pub. Date: Oct. 16, 2025

(54) MODULAR CONNECTOR

(71) Applicant: P-TWO INDUSTRIES INC., Taoyuan City (TW)

(72) Inventors: Chun-Wei CHANG, Taoyuan City (TW); Jeng-Yi YOU, Taoyuan City (TW); Wang-Kun TSAI, Taoyuan City (TW)

(21) Appl. No.: 18/936,231

(22) Filed: Nov. 4, 2024

(30) Foreign Application Priority Data
Apr. 12, 2024 (TW) 113113680

(51) Int. Cl. H01R 13/514; H01R 12/70; H01R 12/71

(52) U.S. Cl. CPC H01R 13/514; H01R 12/707; H01R 12/716

(57) ABSTRACT

The modular connector is disposed on a printed circuit board for insertion by a mating connector. The modular connector includes at least one signal module, a plurality of power modules, and a cover. Each signal module includes a first insulating housing and a plurality of first contact elements. Each power module includes a second insulating housing and a plurality of second contact elements. The at least one signal module is detachably connected between the power modules, and the mating connector has a plurality of signal contact elements and a plurality of power contact elements. When electrically connected, the signal contact elements and the power contact elements respectively correspond to and make contact with the first contact elements and the second contact elements. The modular connector is able to simultaneous transmit signals and currents, and the signal modules and the power modules offer combinational selectivity.

### CROSS REFERENCE TO RELATED APPLICATION

This application claims the benefit of Taiwan Patent Application Serial No. 113113680 filed on Apr. 12, 2024, the subject matter of which is incorporated herein by reference.

### BACKGROUND OF THE INVENTION

### 1. Field of the Invention

The present invention relates to a modular connector, especially a modular connector comprising a combination of power module and signal module.

### 2. Description of Related Art

Board-to-board connectors are a common type of electrical connector used to connect two circuit boards, enabling the transmission of signals, data, and power. Especially in the automotive field, it is necessary to transmit both high-current power and signals simultaneously. However, conventional board-to-board connector designs have certain limitations, such as fixed designs for the plug connector and receptacle connector, which means that the contact positions for the signal terminals and power terminals are fixed. As the market demand for board-to-board connectors is increasing, the number of terminals and installation flexibility of connectors also need to be continuously adjusted to meet various application requirements.

There are some inherent flaws in the current design of board-to-board connectors. First, the fixed position of the terminals limits the flexibility of connectors, making it difficult to adapt to circuit boards of different sizes and layouts. This may lead to design and layout restrictions, increasing the complexity and cost of the system. Secondly, fixed connector designs are susceptible to mechanical stress, especially when they are frequently connected and disconnected, which can easily lead to connector damage and reduce system reliability and lifespan. Furthermore, the installation speed of conventional connectors is slow, limiting production efficiency and leading to increased costs. In the case of mass production, production efficiency needs to improve to meet market demands. For automotive applications that require simultaneous high-current transmission, conventional connector designs may not meet the high-current requirements, resulting in performance limitations and safety concerns.

In view of this, the present invention provides a modular connector for board-to-board connections to address issues faced by conventional board-to-board connectors, such as the inability to adjust the terminal position, low installation efficiency, and the ease of generating high temperatures.

### SUMMARY OF THE INVENTION

The objective of the present invention is to provide a modular connector, which includes signal module and power module connection assemblies. The signal module and the power module are both disposed on the printed circuit board. The signal module and the power module have engaging parts that can be connected to each other correspondingly. Users can form a modular connector with a different number of module combinations through their respective engaging parts according to the actual connector usage needs. Additionally, individual modules can be easily connected or disconnected. As a result, the modular connector enables quick installation and offers high flexibility in adjusting the number of terminals for signal and power connections.

To achieve the above-mentioned objective, the present invention discloses a modular connector disposed on a printed circuit board for insertion by a mating connector. The modular connector comprises at least one signal module, a plurality of power modules, and a cover. The at least one signal module includes a first insulating housing and a plurality of first contact elements. The first contact elements are disposed in the first insulating housing and are arranged adjacently along a first direction. Each power module includes a second insulating housing and a plurality of second contact elements. The second contact elements are disposed in the second insulating housing and are arranged adjacently along the first direction. The at least one signal module is detachably connected between the power modules, and the mating connector has a plurality of signal contact elements and a plurality of power contact elements.

In one embodiment of the present invention, the at least one signal module further includes two first engaging portions. The power module further includes at least one second engaging portion. The first engaging portions are respectively formed on corresponding sides of the first insulating housing, and the at least one second engaging portion is formed on an end of the second insulating housing adjacent to the signal module. The first engaging portions are correspondingly connected to the at least one second engaging portion

In one embodiment of the present invention, the modular connector further comprises a cover disposed on an end of the first insulating housing away from the printed circuit board. The cover further has a main body and a plurality of extension sections. The extension sections extend from the main body in a second direction, which is perpendicular to the first direction.

In one embodiment of the present invention, the first insulating housing includes a first housing body and a plurality of first accommodating slots. The first accommodating slots are disposed in the first housing body to partially receive the first contact elements. The second insulating housing includes a second housing body and a plurality of second accommodating slots. The second accommodating slots are disposed in the second housing body to partially receive the second contact elements.

In one embodiment of the present invention, the first insulating housing further includes a plurality of recessed portions formed on opposite sides of the first housing body for engaging with the extension sections.

In one embodiment of the present invention, the power module further includes a pressing element. The second insulating housing further includes a through slot formed on the side of the second housing body that does not contact the at least one signal module. The pressing element is correspondingly disposed in the through slot.

In one embodiment of the present invention, the first contact element includes a first fixing portion and a first contact portion. The second contact element includes a second fixing portion and at least one second contact portion. The first fixing portion and the second fixing portion are respectively embedded in the first accommodating slot and the second accommodating slot. When the modular connector is engaged, the first contact portion and the at least one second contact portion correspondingly contact with the signal contact element and the power contact element respectively.

In another embodiment of the present invention, the second contact elements are arranged in pairs in each of the second accommodating slots.

In another embodiment of the present invention, the at least one signal module consists of a plurality of signal modules. The signal modules and the power modules are arranged in a staggered configuration.

In one embodiment of the present invention, the first contact element further includes a first solder foot. The second contact element includes at least one second solder foot. The first solder foot and the at least one second solder foot are soldered to the printed circuit board.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a modular connector in an engaged state according to the first embodiment of the present invention;

FIG. 2 is a schematic view of a modular connector in an unengaged state according to the first embodiment of the present invention;

FIG. 3 is a schematic view of the mating connector according to the first embodiment of the present invention;

FIG. 4 is another schematic view of the mating connector according to the first embodiment of the present invention;

FIG. 5 is a schematic view of the modular connector according to the first embodiment of the present invention;

FIG. 6 is another schematic view of the modular connector according to the first embodiment of the present invention;

FIG. 7 is an exploded view of the mating connector according to the first embodiment of the present invention;

FIG. 8 is an exploded view of the modular connector according to the first embodiment of the present invention;

FIG. 9 is a schematic view of the power module and the signal module of the mating connector according to the first embodiment of the present invention;

FIG. 10 is a schematic view of the power module and the signal module of the modular connector according to the first embodiment of the present invention;

FIG. 11 is a schematic view of the second contact element according to the first embodiment of the present invention;

FIG. 12 is a schematic view of the second contact element in contact according to the first embodiment of the present invention;

FIG. 13 is a schematic view of the second contact element according to the second embodiment of the present invention;

FIG. 14 is a schematic view of the modular connector according to the third embodiment of the present invention; and

FIG. 15 is a schematic view of the modular connector according to the fourth embodiment of the present invention.

### DETAILED DESCRIPTION OF THE PREFERRED EMBODIMENT

Reference will now be made in detail to the present embodiments of the invention, examples of which are illustrated in the accompanying drawings, and are not intended to limit the present invention, applications or particular implementations described in these embodiments. Wherever possible, the same reference numbers are used in the drawings and the description to refer to the same or like parts. It shall be appreciated that, in the following embodiments and the attached drawings, elements unrelated to the present invention are omitted from depiction; and dimensional relationships among individual elements in the attached drawings are provided only for ease of understanding, but not to limit the actual scale.

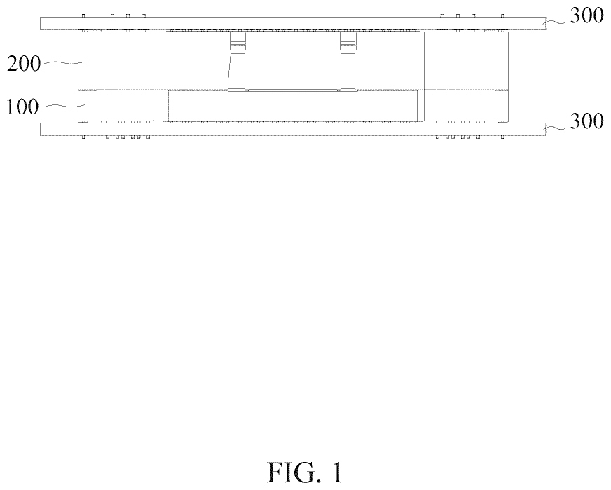

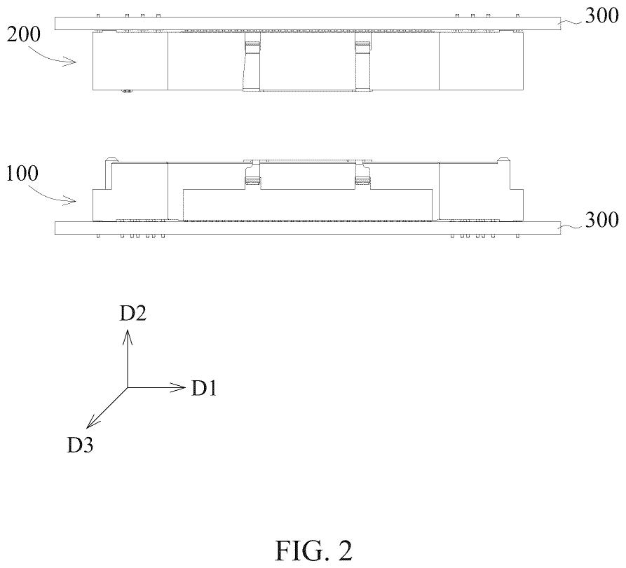

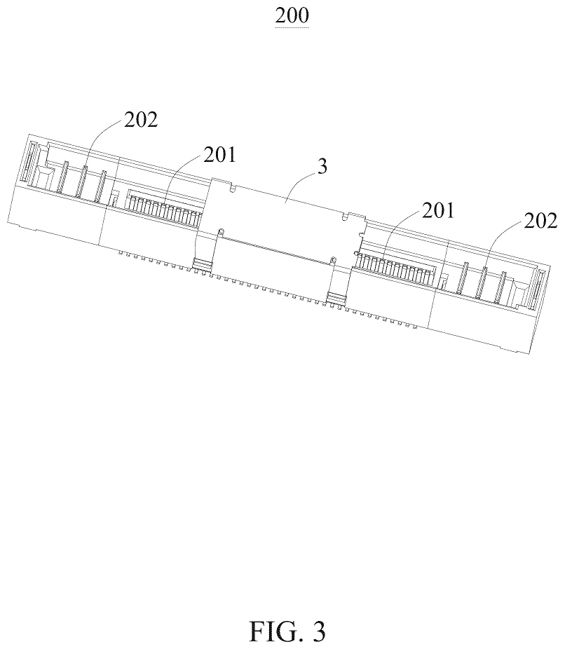

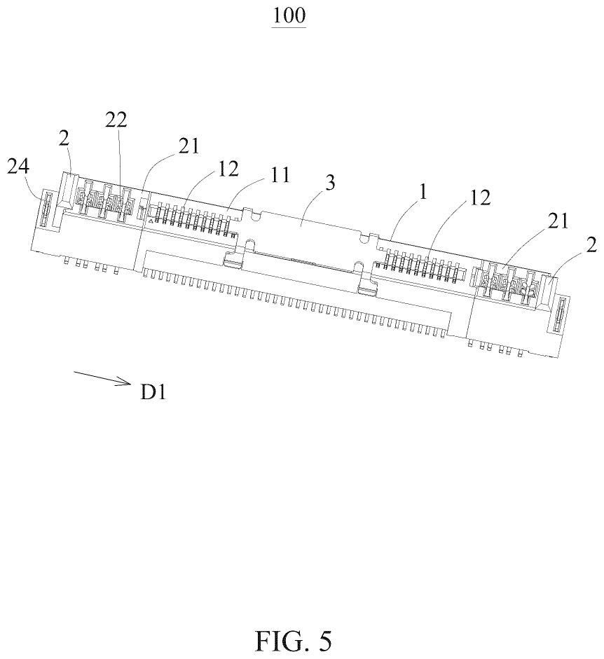

Please refer to FIG. 1 to FIG. 3 and FIG. 5. FIG. 1 is a schematic view of the modular connector 100 in an engaged state according to the first embodiment of the present invention. FIG. 2 is a schematic view of the modular connector 100 in an unengaged state according to the first embodiment of the present invention. FIG. 3 and FIG. 5 are schematic views of the mating connector 200 and the modular connector 100, respectively, according to the first embodiment of the present invention. The modular connector 100 of the present invention is disposed on a printed circuit board 300 to mate with a mating connector 200. The mating connector 200 is also disposed on another printed circuit board 300. The mating connector 200 further includes a plurality of signal contact elements 201 and a plurality of power contact elements 202.

In the embodiment of the present invention, the modular connector 100 is specifically a receptacle connector, and the mating connector 200 is specifically a plug connector for coupling with the modular connector 100. Both connector structures are substantially similar and both can be used for transmitting signals and power. The modular connector 100 includes a signal module 1, two power modules 2, and a cover 3. In this embodiment, the signal module 1 is detachably connected between the power modules 2. The cover 3 is disposed at an end of the signal module 1 away from the printed circuit board 300. It should be noted that in this embodiment, the number and arrangement of the signal module 1 and the power modules 2 are taken as an example of a power-signal-power module combination. The connection positions and the number of modules can be adjusted according to actual usage needs and are not limited thereto.

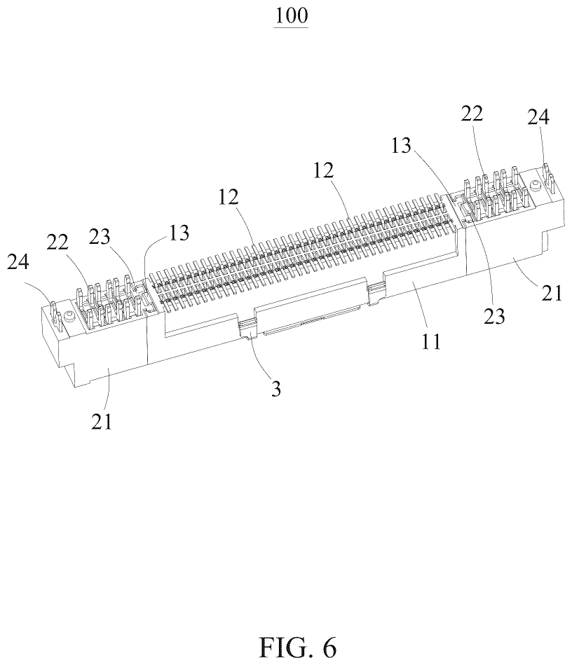

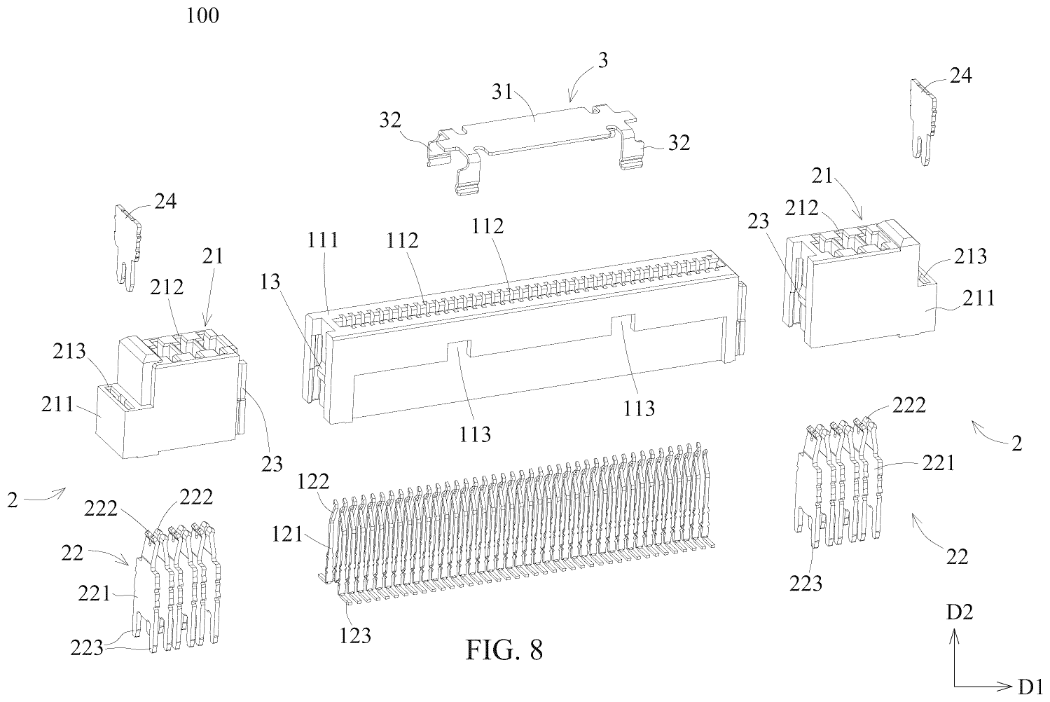

Next, please refer to FIG. 6 and FIG. 8 for the description of the signal module 1. FIG. 6 shows another schematic view of the modular connector 100, and FIG. 8 shows an exploded view of the modular connector 100. The signal module 1 includes a first insulating housing 11, a plurality of first contact elements 12, and two first engaging portions 13. The first contact elements 12 are disposed in the first insulating housing 11 and are arranged adjacently along a first direction D1. The first engaging portions 13 are respectively formed on the two corresponding sides of the first insulating housing 11. Specifically, the first insulating housing 11 further includes a first housing body 111, a plurality of first accommodating slots 112, and four recessed portions 113. The first accommodating slots 112 are disposed in the first housing body 111 to partially receive the first contact elements 12. The recessed portions 113 are formed on opposite sides of the first housing body 111, and two recessed portions 113 are formed on each side for the cover 3 to be engaged. It should be noted that the position and the number of recessed portions 113 can be adjusted according to actual assembly conditions and are not limited thereto.

In details, each of the first contact elements 12 includes a first fixing portion 121, a first contact portion 122, and a first solder foot 123. When the first contact element 12 is disposed in the first accommodating slot 112, the first fixing portion 121 is embedded in the first accommodating slot 112, and the first solder foot 123 is soldered to the printed circuit board 300. When the modular connector 100 is in an engaged state, the first contact portion 122 interferingly contacts a portion of the signal contact element 201.

Reference is next made to FIG. 6 and FIG. 8 for illustrating the power module 2. The power module 2 includes a second insulating housing 21, a plurality of second contact elements 22, a second engaging portion 23, and a pressing element 24. The second contact elements 22 are disposed in the second insulating housing 21 and are arranged adjacently along the first direction D1. The second engaging portion 23 is formed at an end of the second insulating housing 21 near the signal module 1. The second engaging portion 23 is correspondingly connected to the first engaging portion 13, allowing the adjacent signal modules 1 and/or the power modules 2 to be connected to each other.

Specifically, the second insulating housing 21 further includes a second housing body 211, three second accommodating slots 212, and a through slot 213. The second accommodating slots 212 are disposed in the second housing body 211 to partially receive the second contact elements 22. The through slot 213 is formed on the side of the second housing body 211 that does not contact the signal module 1, so that the pressing element 24 can be correspondingly disposed therein. By soldering the pressing element 24 to the printed circuit board 300, the modular connector 100 can be securely disposed on the printed circuit board 300. It should be noted that the position and the number of through slots 213 can be adjusted according to actual assembly conditions and are not limited thereto.

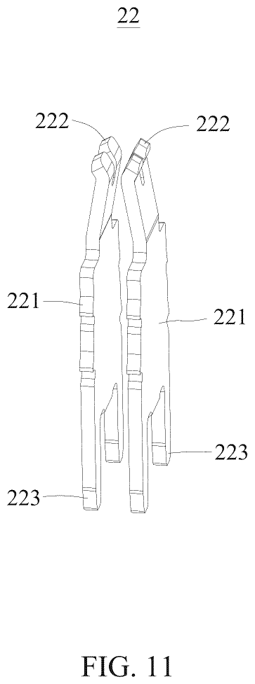

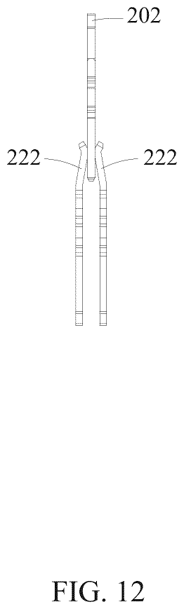

In details, each of the second contact elements 22 includes a second fixing portion 221, a second contact portion 222, and two second solder feet 223. When the second contact element 22 is disposed in the second accommodating slot 212, the second fixing portion 221 is embedded in the second accommodating slot 212, and the second solder feet 223 are soldered to the printed circuit board 300. When the modular connector 100 is in an engaged state, the second contact portion 222 interferingly contacts a portion of the power contact element 202 so that the modular connector 100 is electrically connected. It should be noted that, as shown in FIG. 6, FIG. 11, and FIG. 12, in the first embodiment of the present invention, the second contact elements 22 are arranged in pairs in each of the second accommodating slots 212. In other words, the second contact elements 22 are arranged in groups of two in each of the second accommodating slots 212. The two second contact portions 222 of the second contact element 22 are used to contact and clamp the power contact elements 202 of the mating connector 200. Furthermore, each of the second contact elements 22 has two second solder feet 223. When current flows through the second solder feet 223, the dispersion of the solder feet helps reduce the generation of high temperatures associated with high currents used for electrical connections, resulting in better heat dissipation.

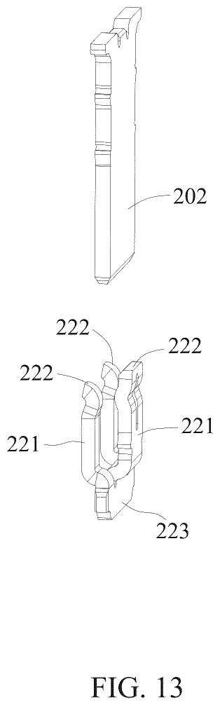

However, please also refer to FIG. 13. In the second embodiment of the present invention, the second contact element 22 is disposed in each second accommodating slot 212 and is integrally bent in two directions to form a structure with a plurality of second fixing portions 221 and a plurality of second contact portions 222. Each of the second contact elements 22 has only one second solder foot 223.

Please refer to FIG. 5 and FIG. 8 again. The cover 3 further includes a main body 31 and four extension sections 32. The extension sections 32 extend from the main body 31 in a second direction D2, wherein the second direction D2 is perpendicular to the first direction D1. The extension sections 32 correspondingly engage with the recessed portions 113 of the first insulating housing 11. It should be noted that the position and number of the extension sections 32 can be adjusted according to actual assembly conditions and are not limited thereto.

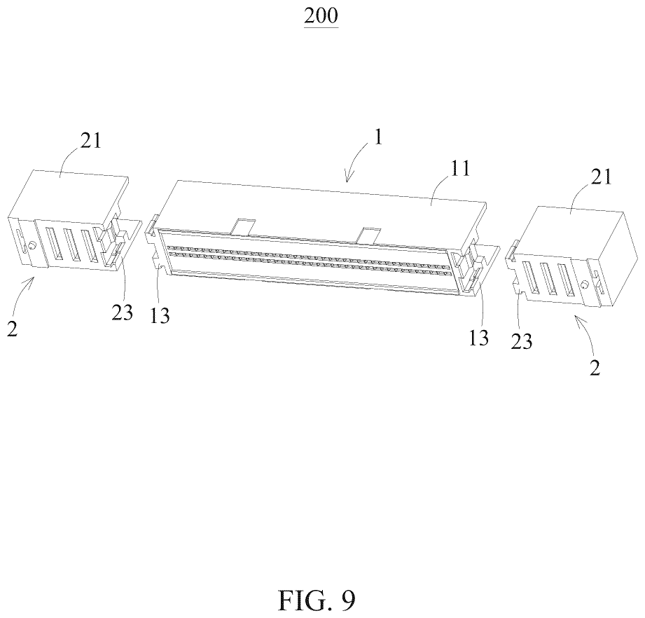

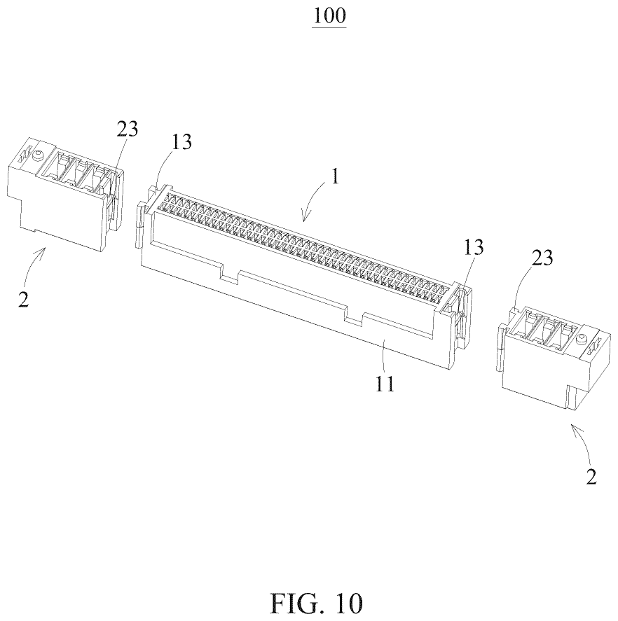

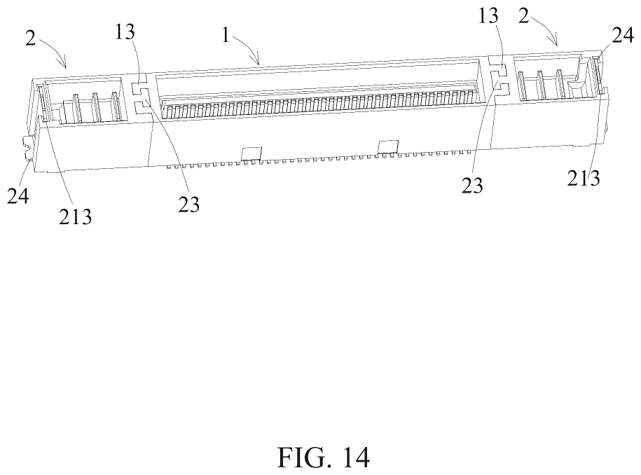

To further illustrate the combination of the signal module 1 and the power modules 2 of the present invention, as shown in FIG. 9 and FIG. 10. In the first embodiment of the present invention, two first engaging portions 13 are formed on both sides of the first insulating housing 11 and respectively engage with the corresponding second engaging portions 23 of the second insulating housings 21 adjacent to both sides. The first engaging portions 13 and the second engaging portions 23 respectively have structures of grooves and/or engaging blocks. In the first embodiment, the first engaging portion 13 on both sides are respectively a groove and an engaging block. The first engaging portion 13 with the groove corresponds to the second engaging portion 23 with the engaging block structure. Conversely, the first engaging portion 13 with the engaging block corresponds to the second engaging portion 23 with the groove structure (as shown in FIG. 9). On the other hand, in the third embodiment of the present invention, the first engaging portions 13 on both sides are symmetrically grooved structures. The first engaging portions 13 with grooves correspond to the second engaging portions 23, which are symmetrically engaging block structures (as shown in FIG. 14). It should be noted that the structure of the first engaging portion 13 and the second engaging portion 23 can be adjusted according to the actual assembly conditions and is not limited thereto.

Additionally, in this embodiment, the combination direction of the first engaging portion 13 and the second engaging portion 23 includes mating with each other along the second direction D2, or mating with each other along a third direction D3 perpendicular to the second direction D2 (not shown in the figures).

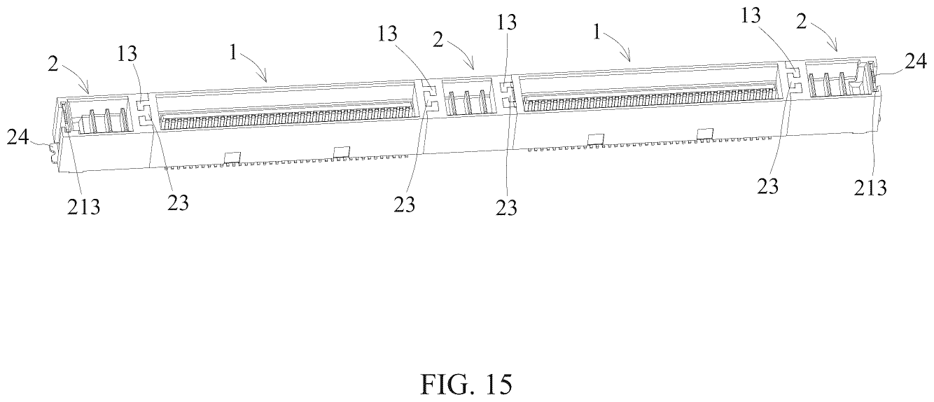

In the fourth embodiment of the present invention, please also refer to FIG. 15. The number of signal modules 1 can be two, and the number of the corresponding combination of power modules 2 can be three. The signal modules 1 and the power modules 2 are staggered with each other. Specifically, the power module 2 disposed between the two signal modules 1 has two second engaging portions 23, which are formed on both sides of the second insulating housing 21 for engaging with the first engaging portions 13 of the adjacent signal modules 1. When current flows through the modular connector 100, the multiple dispersed power modules help reduce the generation of high temperatures associated with high currents used for electrical connections, resulting in better heat dissipation. It should be noted that in this embodiment, the number and arrangement of the signal modules 1 and power modules 2, arranged as power-signal-power-signal-power, are shown as an example. The connection positions and number of modules can be adjusted according to actual usage needs and are not limited thereto.

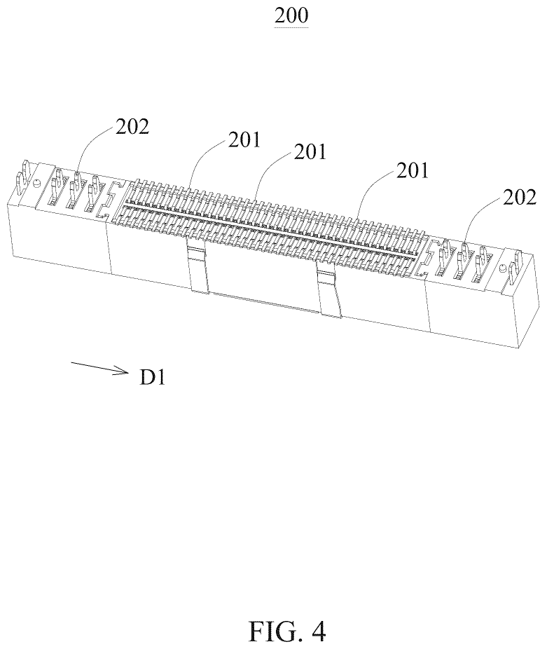

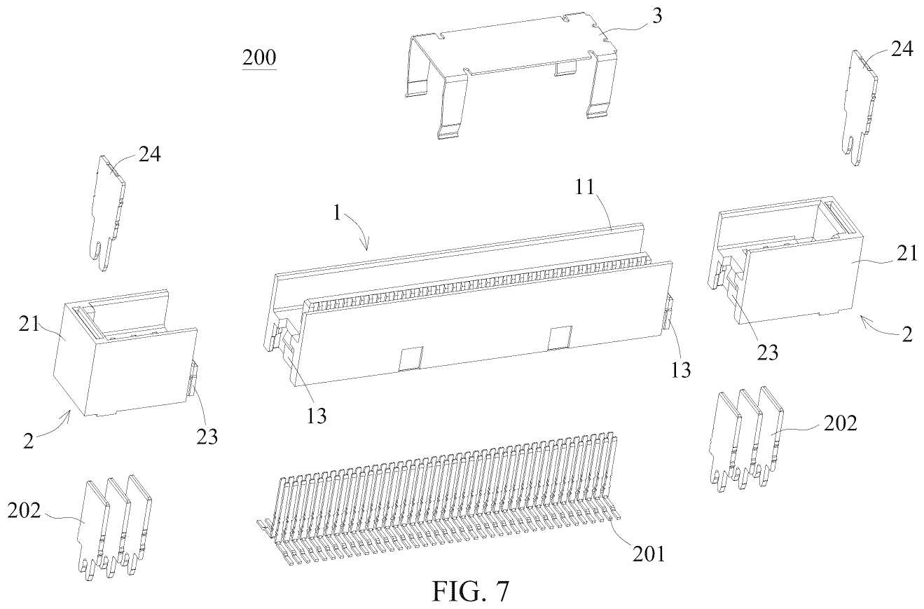

On the other hand, as shown in FIG. 4 and FIG. 7, the mating connector 200 of the present invention differs from the modular connector 100 in that the structural design of its signal module 1, power module 2, and cover 3 are slightly different. Only the differences will be explained here, and the same technical content will not be reiterated. In this case, the signal contact elements 201 of the mating connector 200 correspond to the first contact elements 12 of the signal module 1, and the power contact elements 202 of the mating connector 200 correspond to the second contact elements 22 of the power module 2. In the embodiments of the present invention, the number of the power contact elements 202 is one, and in different embodiments, it can respectively contact either one (as shown in FIG. 13) or two (as shown in FIG. 12) of the second contact elements 22 as a group.

In summary, the modular connector of the present invention includes a combination of signal module and power module. By connecting the engaging portions of the signal module and the engaging portions of the power module, users can select different numbers of independent modules based on the actual needs for signal and power during connection and adjust the number and structure of the interconnected engaging portions. This allows for the design of a customized modular connector with detachable modules, achieving rapid assembly and reducing the high temperatures generated during the passage of high currents.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A modular connector, being disposed on a printed circuit board for insertion by a mating connector, the modular connector comprising:
at least one signal module including a first insulating housing and a plurality of first contact elements, wherein the first contact elements are disposed in the first insulating housing and are arranged adjacently along a first direction; and
a plurality of power modules, each of which including a second insulating housing and a plurality of second contact elements, wherein the second contact elements are disposed in the second insulating housing and are arranged adjacently along the first direction;
wherein the at least one signal module is detachably connected between the power modules, and the mating connector has a plurality of signal contact elements and a plurality of power contact elements.

2. The modular connector as claimed in claim 1, wherein the at least one signal module further includes two first engaging portions, the power module further includes at least one second engaging portion, and the first engaging portions are respectively formed on corresponding sides of the first insulating housing, the at least one second engaging portion is formed on an end of the second insulating housing adjacent to the signal module, and the first engaging portions are correspondingly connected to the at least one second engaging portion.

3. The modular connector as claimed in claim 2, further comprising a cover disposed on an end of the first insulating housing away from the printed circuit board, wherein the cover further has a main body and a plurality of extension sections, the extension sections extend from the main body in a second direction, and the second direction is perpendicular to the first direction.

4. The modular connector as claimed in claim 3, wherein the first insulating housing includes a first housing body and a plurality of first accommodating slots, the first accommodating slots are disposed in the first housing body to partially receive the first contact elements, the second insulating housing includes a second housing body and a plurality of second accommodating slots, and the second accommodating slots are disposed in the second housing body to partially receive the second contact elements.

5. The modular connector as claimed in claim 4, wherein the first insulating housing further includes a plurality of recessed portions formed on opposite sides of the first housing body for engaging with the extension sections.

6. The modular connector as claimed in claim 5, wherein the power module further includes a pressing element, and the second insulating housing further includes a through slot formed on the side of the second housing body that does not contact the at least one signal module, and wherein the pressing element is correspondingly disposed in the through slot.

7. The modular connector as claimed in claim 6, wherein the first contact element includes a first fixing portion and a first contact portion, the second contact element includes a second fixing portion and at least one second contact portion, the first fixing portion and the second fixing portion are respectively embedded in the first accommodating slot and the second accommodating slot, and when the modular connector is engaged, the first contact portion and the at least one second contact portion correspondingly contact with the signal contact element and the power contact element respectively.

8. The modular connector as claimed in claim 4, wherein the second contact elements are arranged in pairs in each of the second accommodating slots.

9. The modular connector as claimed in claim 1, wherein the at least one signal module consists of a plurality of signal modules, and the signal modules and the power modules are arranged in a staggered configuration.

10. The modular connector as claimed in claim 1, wherein the first contact element further includes a first solder foot, the second contact element includes at least one second solder foot, and wherein the first solder foot and the at least one second solder foot are soldered to the printed circuit board.
